(19) United States
(12) Patent Application Publication
(10) Pub. No.: US 2009/0269499 A1
(43) Pub. Date: Oct. 29, 2009

(54) Mixtures, Compositions, and Methods of Using and Preparing Same

(76) Inventor: Ronald Grogan, Spokane, WA (US)

Correspondence Address: WELLS ST. JOHN P.S., 601 W. FIRST AVENUE, SUITE 1300, SPOKANE, WA, 99201, US

(21) Appl. No.: 12/108,288

(22) Filed: Apr. 23, 2008

(51) Int. Cl. B05D 3/02; C08L 33/08; B05D 3/00

(52) U.S. Cl. 427/299; 525/451; 428/407; 427/385.5

(57) ABSTRACT

Mixtures are provided that can include at least one polyhydric alcohol; at least one acrylic compound; and at least one polyhydric ester. Compositions are provided that can include a particle at least partially coated with a mixture can include at least one polyhydric alcohol and a carbonyl compound. Methods for limiting particulate distribution during road use are provided that can include providing a mixture to the surface of the road, the mixture including at least one polyhydric alcohol and a carbonyl compound. Methods for limiting particulate distribution are provided that can include providing a mixture comprising at least one polyhydric alcohol and a carbonyl compound to a surface prior to agitating the surface.

### TECHNICAL FIELD

The present disclosure relates to mixtures, compositions, and methods of using and preparing same.

### BACKGROUND

The sources of airborne dust are too numerous to count. Earthen roads, demolition, excavation, and mining are just a view of the example activities that can generate airborne dust. It would be beneficial to provide a mixture that would limit the generation of this dust.

### SUMMARY OF THE DISCLOSURE

Mixtures are provided that can include at least one polyhydric alcohol; at least one acrylic compound; and at least one polyhydric ester.

Compositions are provided that can include a particle at least partially coated with a mixture can include at least one polyhydric alcohol and a carbonyl compound.

Methods for limiting particulate distribution during road use are provided that can include providing a mixture to the surface of the road, the mixture including at least one polyhydric alcohol and a carbonyl compound.

Methods for limiting particulate distribution are provided that can include providing a mixture comprising at least one polyhydric alcohol and a carbonyl compound to a surface prior to agitating the surface.

### BRIEF DESCRIPTION OF THE DRAWINGS

Embodiments of the disclosure are described below with reference to the following accompanying drawings.

FIG. 1 depicts mixtures, compositions, and methods of using and preparing same according to embodiments of the disclosure.

FIG. 2 depicts mixtures, compositions, and methods of using and preparing same according to embodiments of the disclosure.

FIG. 3 depicts mixtures, compositions, and methods of using and preparing same according to embodiments of the disclosure.

FIG. 4 depicts mixtures, compositions, and methods of using and preparing same according to embodiments of the disclosure.

FIG. 5 depicts mixtures, compositions, and methods of using and preparing same according to embodiments of the disclosure.

FIG. 6 depicts mixtures, compositions, and methods of using and preparing same according to embodiments of the disclosure.

### DESCRIPTION

This disclosure is submitted in furtherance of the constitutional purposes of the U.S. Patent Laws “to promote the progress of science and useful arts” (Article 1, Section 8).

The present disclosure relates to compositions and methods for applying compositions and mixtures. The mixtures can be applied using methods to form compositions during dust inhibition, dust control, dust suppressant, palliative retardant control, and/or for the use of the control of fugitive airborne dust. Application of the mixtures disclosed herein can be done with conventional hydroseeding equipment, a water truck, spray equipment with nozzles or a spreader bar, for example. Large droplets can be provided from this dispersion equipment. In some circumstances, the pre-wetting of surfaces for application can be used before application of the mixtures. One example benefit of the mixtures is that embodiments of the mixtures can be stored in freezing conditions.

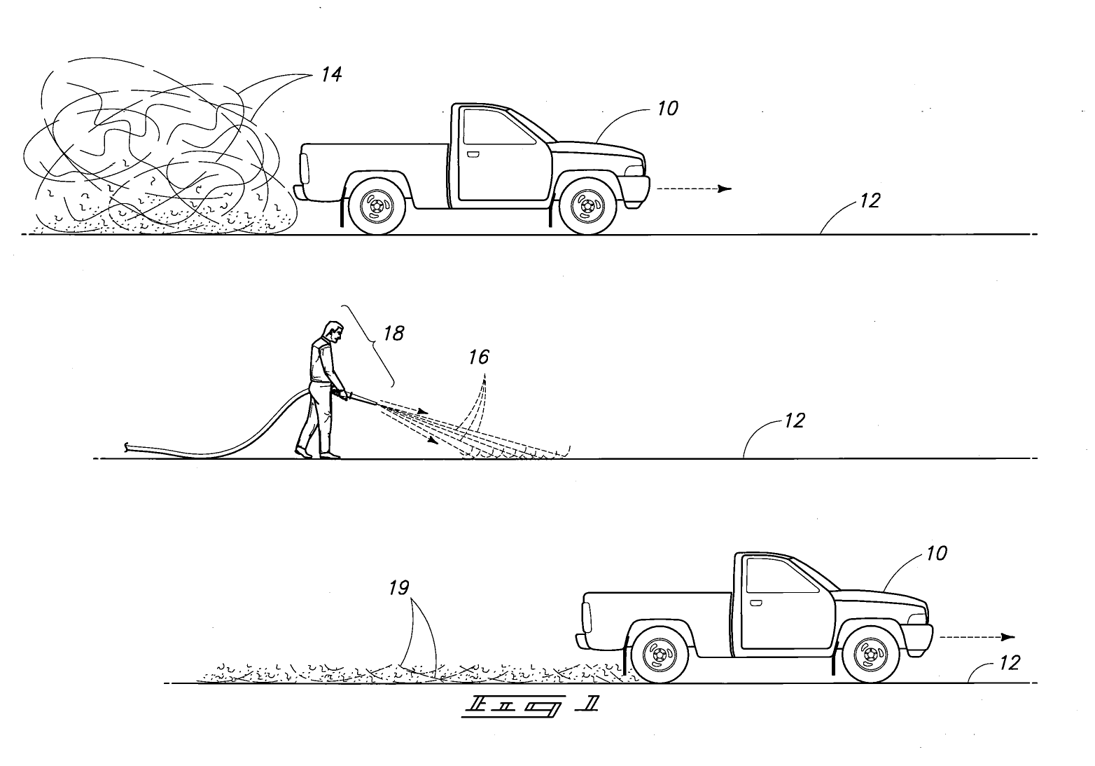

The present disclosure will be described with reference to FIGS. 1-6. Referring to FIG. 1, a vehicle 10 can proceed over a road surface 12 and following the vehicle is an amount of dust or particulate matter 14 generated through the agitation of the road surface. As an example, mixture 16 can be applied to road surface 12. The mixture of the present disclosure can include at least one polyhydric alcohol, at least one acrylic compound, and/or at least one polyhydric ester, for example. According to an example implementation, the mixture applied to a surface such as road surface 12 can include at least one polyhydric alcohol and at least one carbonyl compound. According to one implementation, the mixture can include glycerine, an acrylic copolymer, and at least one polyhydric ester. Still according to other implementations, the mixture can include only at least one polyhydric alcohol.

The polyhydric alcohol of the mixture can include C-3 alcohols that include more than multiple hydroxyl groups. An example of this polyhydric alcohol can include glycerine. The glycerine can be obtained from sources such as, but not limited to, the waste stream of the biodiesel manufacturing process. As an example, the glycerine can be obtained from sources such as Whole Energy, 664 East Laurel Road, Bellingham, Wash. 98226. The glycerine can include minor impurities such as methanol and/or inorganic salts. The glycerine utilized may include as much as and/or less than 18% water but less than 1% ash and approximately 0.5% of fatty acid. The mixture can include at least about 84% by weight of the at least one polyhydric alcohol, such as the glycerine described above.

Referring to FIG. 1, according to an example embodiment, application of mixture 16 is provided to surface 12 via a user 18 operating hose equipped with a spray nozzle.

The mixture can also include at least one acrylic compound such as a copolymer of acrylate and acrylamide. This acrylic compound can be at least about 5% by weight of the mixture. The acrylic compound can be made by the copolymerization of a sodium acrylate and an acrylamide. According to an example embodiment, this acrylic compound can be obtained from Ciba Specialty Chemicals Corporation at 2301 Wilroy Road, Suffolk, Va. 23434.

As another component of the mixture, the one polyhydric ester can include a C-5 compound having multiple methyl groups. As an example, the C-5 compound can include multiple methyl groups. As an example, the C-5 compound can include four methyl groups. The polyhydric ester can be a propyl ester, and furthermore can be a butyl ester that includes a propane backbone and a methyl group extending therefrom. The C-5 compound can include one or more hydroxyl groups such as pentanediol and the diols can be located at the 1 and 3 positions of the compound backbone. An example of this compound can include the compound 2,2,4-trimethyl-1,3-pentanediol mono(2-methylpropanoate). This polyhydric ester can comprise at least about 6% of the mixture.

The mixture can include as much as 4% of water as well. As alluded to earlier, the mixture 16 can be applied to surface 12 to at least partially coat particles or unfixed particles upon road 12 with the mixture. Application of the mixture can affix free particles to the surface to form a hardened surface. The particles of surface 12 can be at least 10 μm in diameter, or at least 90 μm in diameter, for example.

The application of the mixture to the surface can provide a composition that includes a particle at least partially coated with the mixture, wherein the mixture includes at least one polyhydric alcohol and a carbonyl compound. Upon application of the mixture to the surface, a composition can be provided that includes a plurality of particles in combination with the mixture. According to an example embodiment, the mixture can couple at least two of the plurality of particles that are part of the composition. The composition can also include the particles themselves, the mixture, and a stationary structure such as a road bed, for example. The mixture can couple the particles to this stationary structure.

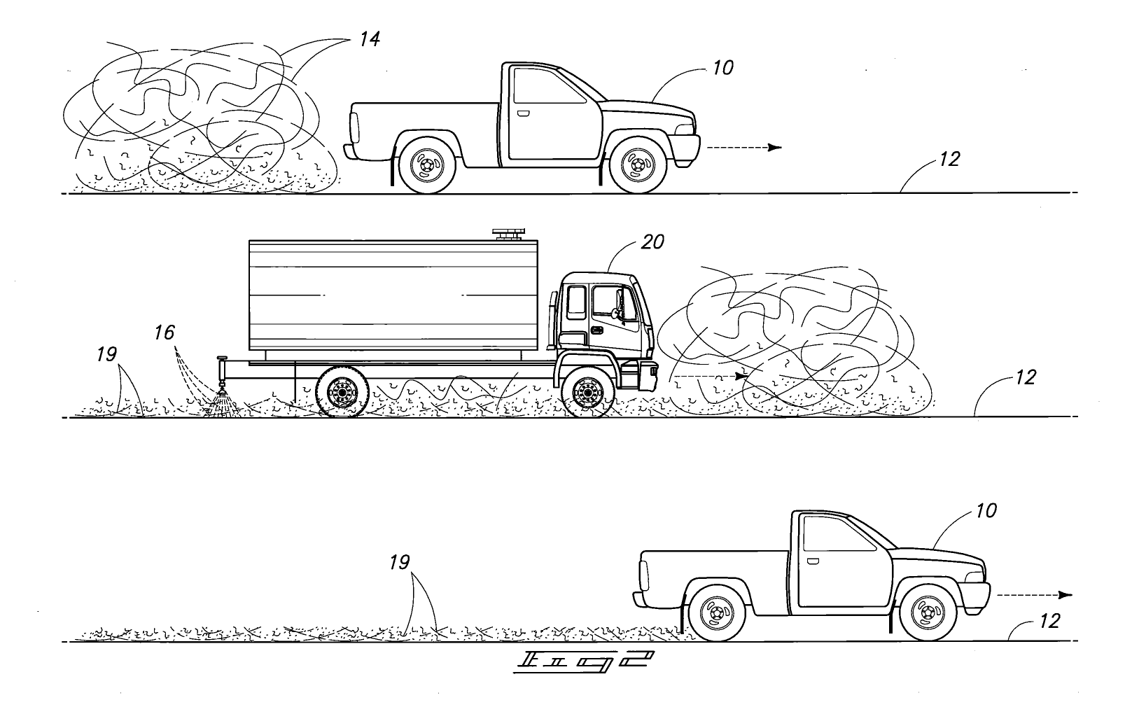

According to an example embodiment, a method for limiting particle distribution during road use can include providing mixture 16 to surface 12. As depicted for example purposes in FIG. 1, vehicle 10, after utilizing surface 12 as a roadbed, can provide less dust particulate matter in its wake. Referring to FIG. 2, vehicle 10 can also proceed over road bed 12 and generate dust amount 14 in its wake. Either behind vehicle 10 or prior to vehicle 10 proceeding over road bed 12, a distribution apparatus such as a water truck or spreader truck 20 can be utilized to provide mixture 16 to road bed 12. Upon application of mixture 16 to road bed 12, limited dust or particulate matter 19 is generated. Prior to providing the mixture, surface 12 can be pre-wetted with an aqueous solution. The pre-wetting can include distributing water to surface 12. According to an example embodiment, the application of mixture 16 to surface 12 can harden surface 12. This hardening can include coupling a plurality of loose particles to a fixed portion of surface 12. According to an example embodiment, the mixture can include water and the hardening can include dehydrating at least a portion of the mixture after providing the mixture to harden the surface.

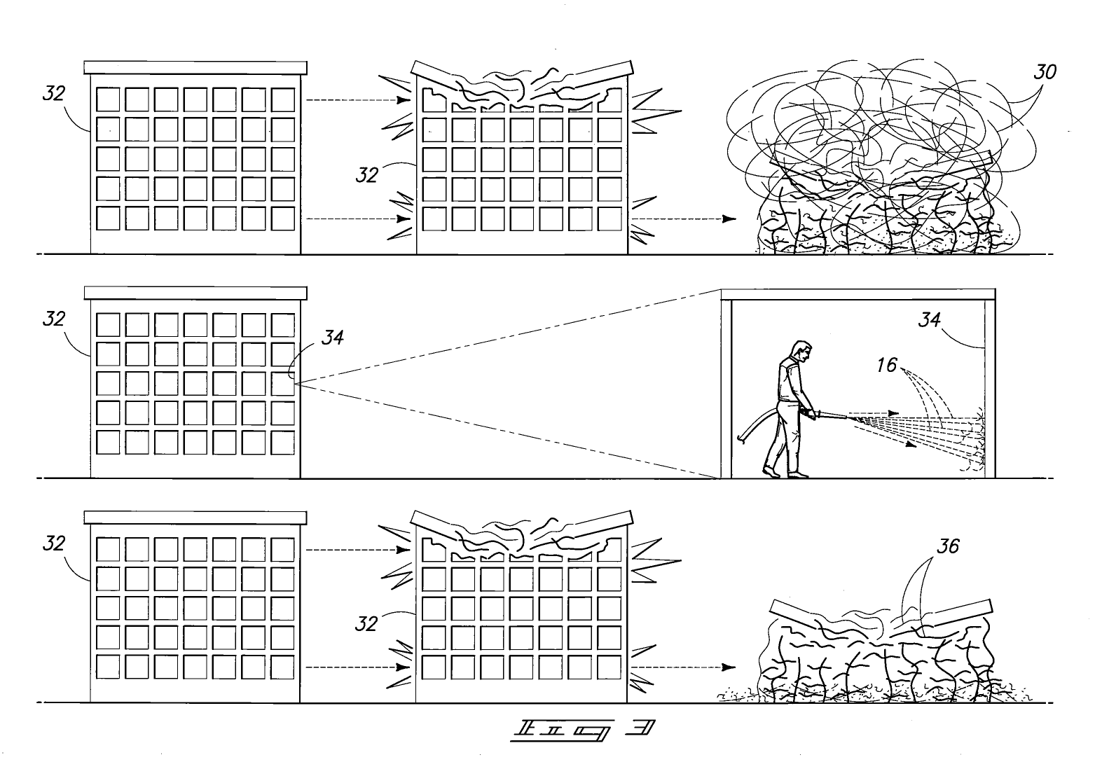

Referring to FIGS. 3, 4, and 5, multiple examples of methods for limiting particulate distribution are depicted that can include providing a mixture comprising the at least one polyhydric alcohol and a carbonyl compound to a surface prior to agitating the surface. An example of agitation of the surface is given in these three figures, but other forms of generating fugitive airborne dust that may be remedied through application of the mixtures disclosed herein are contemplated.

Referring to FIG. 3, building demolition is depicted in the first frame that can generate a substantial amount of particulate matter 30. Referring to second frame, within the building itself, application of mixture 16 can be applied to a surface 34 of building 32. In the example depicted embodiment, surface 34 is an interior surface of building 32, however exterior or alternative surfaces of the building may receive application as well. The surface of building 32 can be agitated through the demolition of building 32, and after application of mixture 16 to surface 34, the demolition of building 32 may generate a limited amount of particulate matter 36.

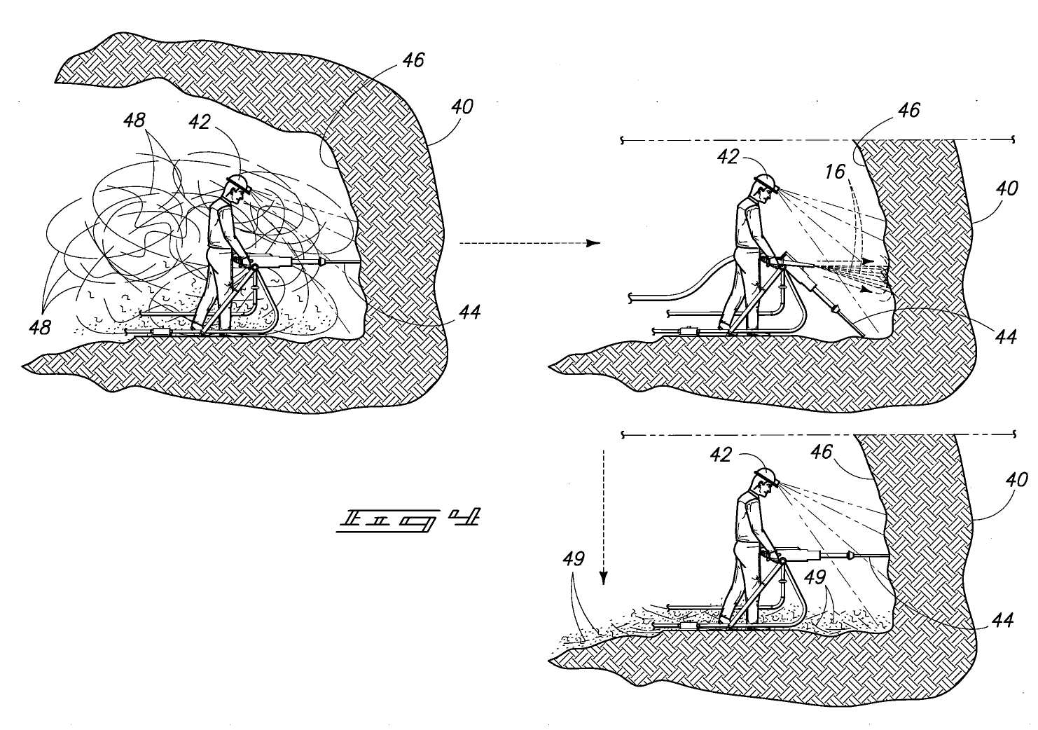

Referring to FIG. 4, in the first frame 40, a mining operation is depicted wherein miner 42 is operating a drill 44 to agitate surface 46 and generate particulate matter 48. According to example embodiments, drill 44 can be equipped with a mixture application apparatus, or prior to utilizing, mixture 16 can be applied to surface 46. Upon agitation of surface 46 with drill 44, after application of mixture 16, limited particulate matter 49 is generated.

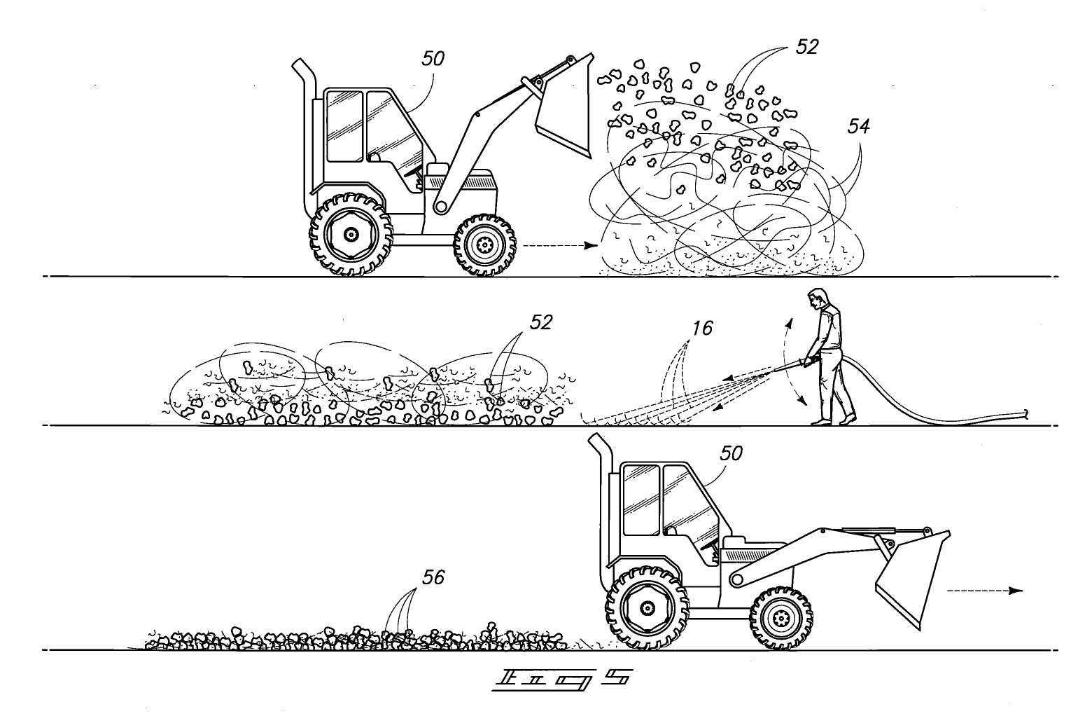

According to another example depicted in FIG. 5, earthen piles are generated utilizing vehicles 50 such as a front loader to generate earthen pile 52. The generation of this earthen pile can generate substantial particulate matter 54. The earthen pile can include coal fragments, for example, other mining waste as is typically generated, including gravel or any other earthen materials. Application of mixture 16 to earthen pile 52 can generate substantially less particulate matter 54, and then the loading of additional earthen materials can generate substantially less particulate matter 56.

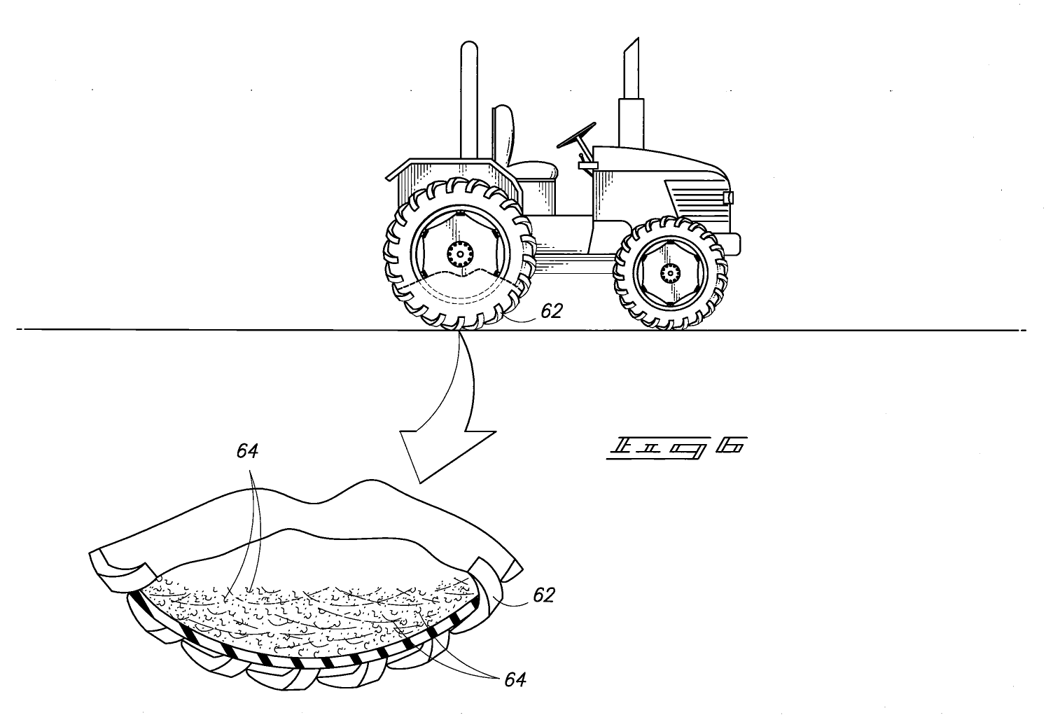

According to an additional embodiment, mixture 16 can include a polyhydric alcohol and this mixture can be utilized as a tire ballast for example. With reference to FIG. 6, vehicle 60 can include tires 62. Within tires 62 can include a ballast material 64. This ballast material can include a polyhydric alcohol such as the polyhydric alcohol as described herein. Furthermore, this ballast material can also be consistent with mixture 16 provided herein.

In compliance with the statute, embodiments of an invention have been disclosed in language more or less specific as to structural and methodical features. It is to be understood, however, that the invention is not limited to the specific embodiments shown and described, since the means herein disclosed comprise forms of putting the invention into effect. The invention is, therefore, claimed in any of its forms or modifications within the proper scope of the appended claims appropriately interpreted in accordance with the doctrine of equivalents.

What is claimed is:

1. A mixture comprising:
at least one polyhydric alcohol;
at least one acrylic compound; and
at least one polyhydric ester.

2. The mixture of claim 1 wherein:
the at least one polyhydric alcohol is glycerine;
the at least one acrylic compound is a copolymer of acrylate and the at least one polyhydric ester is 2,2,4-trimethyl-1,3-pentanediol mono(2-methylpropanoate).

3. The mixture of claim 1 wherein at least about 84% of the mixture is the at least one polyhydric alcohol.

4. The mixture of claim 1 wherein at least about 6% of the mixture is the at least one polyhydric ester.

5. The mixture of claim 1 wherein at least about 5% of the mixture is the at least one acrylic compound.

6. A composition comprising a particle at least partially coated with a mixture comprising at least one polyhydric alcohol and a carbonyl compound.

7. The composition of claim 6 wherein the particle is at least 10 μm in diameter.

8. The composition of claim 6 wherein the particle is at least 90 μm in diameter.

9. The composition of claim 6 further comprising a plurality of particles.

10. The composition of claim 9 wherein the mixture couples at least two of the plurality of particles.

11. The composition of claim 6 further comprising a stationary structure.

12. The composition of claim 11 wherein the mixture couples the particle to the stationary structure.

13. A method for limiting particulate distribution during road use comprising providing a mixture to the surface of the road, the mixture comprising at least one polyhydric alcohol and a carbonyl compound.

14. The method of claim 13 wherein the providing comprises distributing through hydroseeding equipment and/or spray equipment.

15. The method of claim 13 further comprising pre-wetting the surface prior to providing the mixture.

16. The method of claim 15 wherein the pre-wetting comprises distributing water to the surface.

17. The method of claim 13 wherein the mixture comprises:
glycerine;
an acrylic copolymer; and
at least one polyhydric ester.

18. The method of claim 17 wherein the one polyhydric ester is 2,2,4-trimethyl-1,3-pentanediol mono(2-methylpropanoate).

19. The method of claim 13 further comprising hardening the surface.

20. The method of claim 19 wherein the hardening comprises coupling a plurality of the particles of the surface.

21. The method of claim 19 wherein the mixture further comprises water and the hardening comprises dehydrating at least a portion of the mixture after providing the mixture.

22. A method for limiting particulate distribution comprising providing a mixture comprising at least one polyhydric alcohol and a carbonyl compound to a surface prior to agitating the surface.

23. The method of claim 22 wherein the surface is of a structure to be demolished.

24. The method of claim 23 wherein the mixture is applied to the surface from a hand-held spraying apparatus.

25. The method of claim 22 wherein the surface is an interior portion of mine proximate active drilling.

26. The method of claim 22 wherein the surface is of an earthen pile.

27. A tire ballast mixture comprising at least one polyhydric alcohol.

28. The method of claim 27 wherein the polyhydric alcohol is glycerine.
